(19) United States
(12) Patent Application Publication
(10) Pub. No.: US 2020/0130581 A1
(43) Pub. Date: Apr. 30, 2020

(54) REVERSE IMAGE DISPLAY METHOD

(71) Applicant: BEIJING WEIBOXINTONG TECHNOLOGY CO., LTD., BEIJING (CN)

(72) Inventor: GUOHUI HU, SHENZHEN (CN)

(21) Appl. No.: 16/731,122

(22) Filed: Dec. 31, 2019

(30) Foreign Application Priority Data
Dec. 30, 2019 (CN) 201911389574.1

(51) Int. Cl. B60R 1/00; G06T 5/20; G06T 5/00

(52) U.S. Cl. CPC B60R 1/002; G06T 5/20; H04N 7/183; G06T 5/008; G06T 5/002

(57) ABSTRACT

The invention provides a reverse image display method. An image processing module segments a reverse image into visual saliency image blocks and non-visual saliency image blocks according to visual saliency. The visual saliency image blocks are denoised by a BM3D algorithm, and the non-visual saliency image blocks are denoised by a mean filtering algorithm. The denoised visual saliency image blocks and non-visual saliency image blocks are combined into a final required reverse image which is transmitted to an automobile display screen for display. The visual saliency image blocks are denoised by the BM3D algorithm, so that the obtained image is more easily watched by human eyes, and a driver can conveniently observe a reverse image picture; and the non-visual saliency image blocks are denoised by the mean filtering algorithm, denoising speed can be increased, and the denoising speed can be conveniently increased by a computer as a whole.

### FIELD OF THE INVENTION

The invention relates to the technical field of automobiles, in particular to a reverse image display method.

### BACKGROUND

With popularization of automobiles, automobile reverse images gradually become standard on automobiles. The automobile reverse images can assist drivers in observing the rear situation and avoid accidents. In the prior art, the automobile reverse image system usually consists of an image acquisition module, an image processing module and an automobile display screen. A reverse image acquired by the image acquisition module is converted by the image processing module and then transmitted to the automobile display screen for display. However, the image processing module only performs data format conversion on the acquired reverse image, and the original image is directly transmitted to the automobile display screen for display; and how to enhance quality of the reverse image to obtain better display effect is a problem in the industry.

### SUMMARY

The invention aims to provide a reverse image display method, which can enhance quality of reverse images, facilitate observation of the reverse images for drivers, and improve safety of automobiles.

To achieve the aim, the following technical scheme is adopted:

A reverse image display method for a reverse image processing system, the reverse image processing system comprises an image acquisition module, an image processing module and an automobile display screen, the method comprises the following steps:

The image acquisition module sends a reverse image to the image processing module;

The image processing module segments the reverse image into visual saliency image blocks and non-visual saliency image blocks according to visual saliency;

The visual saliency image blocks are denoised by a BM3D algorithm, and the non-visual saliency image blocks are denoised by a mean filtering algorithm;

The denoised visual saliency image blocks and non-visual saliency image blocks are combined into a final required reverse image which is transmitted to an automobile display screen for display.

Compared with the prior art, the reverse image display method has the following beneficial effects:

The image processing module segments the reverse image into the visual saliency image blocks and the non-visual saliency image blocks according to visual saliency. The visual saliency image blocks are denoised by the BM3D algorithm, and the non-visual saliency image blocks are denoised by the mean filtering algorithm. The denoised visual saliency image blocks and non-visual saliency image blocks are composited into the final required reverse image which is transmitted to the automobile display screen for display. As the reverse image is segmented into the visual saliency image blocks and the non-visual saliency image blocks and the visual saliency image blocks are denoised by the BM3D algorithm, the obtained image is more easily watched by human eyes, and a driver can conveniently observe a reverse image picture, and the non-visual saliency image blocks are denoised by the mean filtering algorithm, denoising speed can be increased while certain image quality is maintained, and the denoising speed can be conveniently increased by a computer as a whole.

### BRIEF DESCRIPTION OF THE DRAWINGS

FIG. 1 provides a flow chart of an embodiment of the reverse image display method of the present invention;

FIG. 2 provides a flow chart of an embodiment of blocking the reverse image according to visual saliency in the reverse image display method of the present invention.

### DETAILED DESCRIPTION

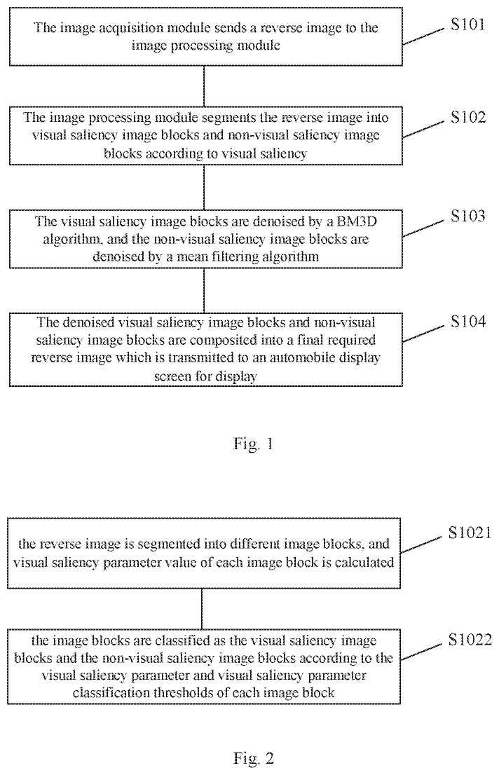

In reference to FIG. 1, the FIG. 1 illustrates a flow diagram of an embodiment of a reverse image display method, an automobile reverse image display system of the embodiment comprises an image acquisition module, an image processing module and an automobile display screen, the method specifically comprises:

S101, the image acquisition module sends a reverse image to the image processing module;

S102, the image processing module segments the reverse image into visual saliency image blocks and non-visual saliency image blocks according to visual saliency, during concrete implementations, for example, as a preferred embodiment, in reference to FIG. 2, the reverse image can be segmented into blocks according to following steps, that is:

S1021, the reverse image is segmented into different image blocks, and visual saliency parameter value of each image block is calculated;

S1022, the image blocks are classified as the visual saliency image blocks and the non-visual saliency image blocks according to the visual saliency parameter and visual saliency parameter classification thresholds of each image block;

During concrete implementations, the visual saliency parameter value of each image block can be calculated by an RC (region-based contrast) algorithm, other algorithms can also be adopted in practice, and there are no specific limitations;

S103, the visual saliency image blocks are denoised by a BM3D algorithm, and the non-visual saliency image blocks are denoised by a mean filtering algorithm;

S104, the denoised visual saliency image blocks and non-visual saliency image blocks are composited into a final required reverse image which is transmitted to the automobile display screen for display.

In the embodiments, in order to improve the display quality of the reverse image, the image processing module needs to denoise the reverse image, but different image qualities are required for each part of the reverse image, for example, for the part caught more attention by human eyes, the requirement for the image quality is high, and for the part caught less attention by human eyes, the requirement for the image quality is low. However, if all parts are denoised, a computer processor needs longer processing time and is low in efficiency, thus, the image processing module in the embodiments segments the reverse image into the visual saliency image blocks and the non-visual saliency image blocks according to visual saliency. The visual saliency image blocks are denoised by the BM3D algorithm, accordingly, the image quality is higher, the processing time is relatively longer, the non-visual saliency image blocks are denoised by the mean filtering algorithm, the image quality is not as good as that obtained by the BM3D algorithm, but the processing time of the computer processor is shorter, finally, the denoised images are composited into the final required reverse image which is transmitted to the automobile display screen for display, and there is no more detailed description.

It should be noted that visual saliency can be measured from multiple parameters, for example, visual saliency can be distinguished from color difference or space distance relation while the visual saliency parameter values can be calculated from color contrast or space distance relation. Specifically, the reverse image is segmented into N*N image blocks, the color contrast is taken as a visual saliency parameter, the color contrast of each image block is calculated, the color contrast value with visual saliency is set as a classification threshold, the color contrast of each image block is compared with the classification threshold of the color contrast, so that the image can be classified as the visual saliency image blocks and the non-visual saliency image blocks. Besides, if space distance is taken as a visual saliency parameter, firstly, the region with visual saliency is determined, further, space distance values between each image block and the region with the visual saliency are calculated, the space distance values of each image block and the classification threshold of the space distances are compared, the image can also be classified as the visual saliency image blocks and the non-visual saliency image blocks, other visual saliency parameters and algorithms can also be adopted in practice, and there is no specific limitation.

The embodiments are merely preferred embodiments, and it is to be understood that the invention is not limited to the disclosed embodiments. Any modifications, equivalent replacement and improvement made within the spirit and principle of the present invention shall be included in the protection scope of the present invention.

1. A reverse image display method for a reverse image processing system, the reverse image processing system comprises an image acquisition module, an image processing module and an automobile display screen, the method is characterized by comprising the following steps:
The image acquisition module sends a reverse image to the image processing module;
The image processing module segments the reverse image into visual saliency image blocks and non-visual saliency image blocks according to visual saliency;
The visual saliency image blocks are denoised by a BM3D algorithm, and the non-visual saliency image blocks are denoised by a mean filtering algorithm.
The denoised visual saliency image blocks and non-visual saliency image blocks are composited into a final required reverse image which is transmitted to an automobile display screen for display.

2. The method of claim 1, characterized in that the image processing module segments the reverse image into the visual saliency image blocks and the non-visual saliency image blocks according to visual saliency, specifically comprising:
Dividing the reverse image into different image blocks and calculating a visual saliency parameter value of each image block;
Dividing the image blocks into the visual saliency image blocks and the non-visual saliency image blocks according to the visual saliency parameter value and visual saliency classification threshold of each image block.

3. The method of claim 2, characterized in that the visual saliency parameter value of each image block is calculated by a RC (region-based contrast) algorithm.
